(19) United States
(12) Patent Application Publication
(10) Pub. No.: US 2026/0249489 A1
(43) Pub. Date: Aug. 27, 2026

(54) Systems and Assemblies Associated with a Tooling Joint

(71) Applicant: Norgren Automation Solutions, LLC, Saline, MI (US)

(72) Inventor: Corey Chappus, Armada, MI (US)

(21) Appl. No.: 19/161,415

(22) PCT Filed: Feb. 20, 2024
(86) PCT No.: PCT/EP2024/054247

§ 371 Date: Sep. 2, 2025

Related U.S. Application Data
(60) Provisional application No. 63/488,305, filed on Mar. 3, 2023.

(51) Int. Cl. B25J 19/00; B25J 15/00; B25J 17/02

(52) U.S. Cl. CPC B25J 19/0004; B25J 15/0061; B25J 17/0241

(57) ABSTRACT

An example joint includes: an electric motor having an output shaft; a clamp having a clamp shaft that is rotatably coupled to the output shaft of the electric motor; a gear that is rotatably coupled to the clamp shaft; a locking module comprising a piston and a lock spring applying a biasing force on the piston; and at least one pawl movable by the piston, wherein (i) as the piston is actuated, the piston moves against the lock spring, allowing the at least one pawl to move away from the gear, and allowing the gear and the clamp shaft to rotate with the output shaft of the electric motor, and (ii) as the piston is unactuated, the lock spring biases the piston, causing the at least one pawl to move toward and engage the gear to lock the gear in position, thereby preventing the clamp shaft from rotating.

### BACKGROUND

In a manufacturing facility, various manufacturing and assembly operations are performed on numerously configured workpieces. Such operations involve manufacturing (e.g., machining, welding, stamping, etc.) and assembly operations being performed on the workpieces as well as operations of handling and shuttling the workpieces between workstations.

A particular operation may be performed on the workpiece at each workstation. Once the operation at the workstation is performed, the workpiece is moved to the next workstation where further operations are to be performed.

Handling and shuttling the workpiece involves using tooling assemblies that attach to the workpiece and moving the workpiece from one workstation to another. To accommodate different types of workpieces and associated operations, the tooling assemblies can take on different configurations. Conventional tooling assemblies use various sections of tubing interconnected by various rigid mounts for fixturing a variety of workpieces, but such designs typically provide little or no adjustment in the tooling assembly. For different workpieces, tools or end-effectors may need to be changed manually, and joints are also adjust manually to place a tooling assembly in a particular desired configuration suitable for a particular workpiece.

Adjusting tooling assemblies and replacing end-effectors for a particular workpiece is a timely and tedious process. Changing the configuration for every workpiece manually, can be time consuming and costly.

It may thus be desirable to provide an automated workpiece transfer system that can be adjusted for any configuration of workpiece without having to manually make any adjustments or replacements. It is with respect to these and other considerations that the disclosure made herein is presented.

### SUMMARY

Within examples described herein, the present disclosure describes implementations that relate to a systems and methods associated with a tooling joint.

In a first example implementation, the present disclosure describes a joint. The joint includes: an electric motor having an output shaft; a clamp having a clamp shaft that is rotatably coupled to the output shaft of the electric motor; a gear that is rotatably coupled to the clamp shaft; a locking module comprising a piston and a lock spring applying a biasing force on the piston; and at least one pawl movable by the piston, wherein (i) as the piston is actuated, the piston moves against the lock spring, allowing the at least one pawl to move away from the gear, and allowing the gear and the clamp shaft to rotate with the output shaft of the electric motor, and (ii) as the piston is unactuated, the lock spring biases the piston, causing the at least one pawl to move toward and engage the gear to lock the gear in position, thereby preventing the clamp shaft from rotating

In a second example implementation, the present disclosure describes a system. The system includes a transfer rail, and a plurality of arms coupled to the transfer rail, each arm having a plurality of joints including the joint of the first example implementation.

In a second example implementation, the present disclosure describes a method of operating a joint. The method includes: providing fluid to a locking module of a joint, thereby causing a piston of the locking module to move to an actuated position, allowing at least one pawl to disengage from a gear of the joint; sending a command signal to an electric motor of the joint, wherein the electric motor has an output shaft, wherein the joint has a clamp having a clamp shaft that is rotatably coupled to the output shaft of the electric motor, and wherein the gear is rotatably coupled to the clamp shaft such that the command signal causes the output shaft, the clamp shaft, and the gear to rotate; discharging fluid from the locking module, causing a lock spring to return the piston to an unactuated position, thereby causing the piston to move the at least one pawl toward and engage the gear to lock the gear in position, preventing the clamp shaft from rotating

The foregoing summary is illustrative only and is not intended to be in any way limiting. In addition to the illustrative aspects, implementations, and features described above, further aspects, implementations, and features will become apparent by reference to the figures and the following detailed description.

### BRIEF DESCRIPTION OF THE FIGURES

The novel features believed characteristic of the illustrative examples are set forth in the appended claims. The illustrative examples, however, as well as a preferred mode of use, further objectives and descriptions thereof, will best be understood by reference to the following detailed description of an illustrative example of the present disclosure when read in conjunction with the accompanying Figures.

FIG. 1 illustrates a system for transferring a workpiece, in accordance with an example.

FIG. 2 illustrates a partial view of a system, in accordance with an example implementation.

FIG. 3 illustrates a partial side view of a joint, in accordance with an example implementation.

FIG. 4 illustrates another joint, in accordance with an example implementation.

FIG. 5 illustrates another joint, in accordance with an example implementation.

FIG. 6 illustrates a perspective exploded view of the joint of FIG. 4, in accordance with an example implementation.

FIG. 7 illustrates a partial exploded perspective view of a gear assembly, in accordance with an example implementation.

FIG. 8 illustrates a transparent perspective view of a locking module, in accordance with an example implementation.

FIG. 9 illustrates a perspective cross-sectional view of the locking module of FIG. 8, in accordance with an example implementation.

FIG. 10 illustrates a side-cross sectional view of the locking module of FIG. 8, in accordance with an example implementation.

FIG. 11 illustrates a partial perspective view of the joint of FIG. 6, in accordance with an example implementation.

FIG. 12 illustrates a partial top view of the joint of FIG. 6, in accordance with an example implementation.

FIG. 13 is a flowchart of a method of operating a joint, in accordance with an example implementation.

### DETAILED DESCRIPTION

Disclosed examples will now be described more fully hereinafter with reference to the accompanying drawings, in which some, but not all of the disclosed examples are shown. Indeed, several different examples may be described and should not be construed as limited to the examples set forth herein. Rather, these examples are described so that this disclosure will be thorough and complete and will fully convey the scope of the disclosure to those skilled in the art.

Disclosed herein are systems, methods, and assemblies associated with a tooling joint that can be used in a workpiece transfer system having multiple arms coupled to a movable rail for use in a manufacturing environment involving successive workstations. The arms operate as tooling assemblies with end-effectors configured to attach to or hold the workpiece to transfer the workpiece between the successive workstations. Particularly, the arms are attached to the movable rail, and the movable rail is actuated to move the arms with the workpiece between two successive workstations.

Each arm can have links coupled to each other via respective joints, and an end-effector can be coupled to an end link of the arm. A controller is configured to unlock the joints, then actuate electric motors to place the arm in a particular configuration in space suitable for a particular workpiece without having to do manual adjustments. Once the arm configuration is achieved, the joints are locked.

The disclosed joint is compact compared to conventional joints. Thus, the disclosed joint allows for tight rotations of the arm links to position the arm and the end-effector in a desired configuration, thereby reducing the space required for each arm.

Once the arm configuration is achieved and the joints are locked, the system is ready to pick the workpiece and move it from one workstation to another. Particularly, the system controller can actuate the rail to place the rail near or on top of the workpiece at a workstation, move the rail toward the workpiece and allow the arms and end-effectors to engage the workpiece, and then move the rail to the next workstation. The workpiece can then be released, and the rail and associated arms are moved out of the way to allow a manufacturing operation to be performed on the workpiece. The system controller then actuates the rail back to the previous workstation where the cycle begins again with the next workpiece.

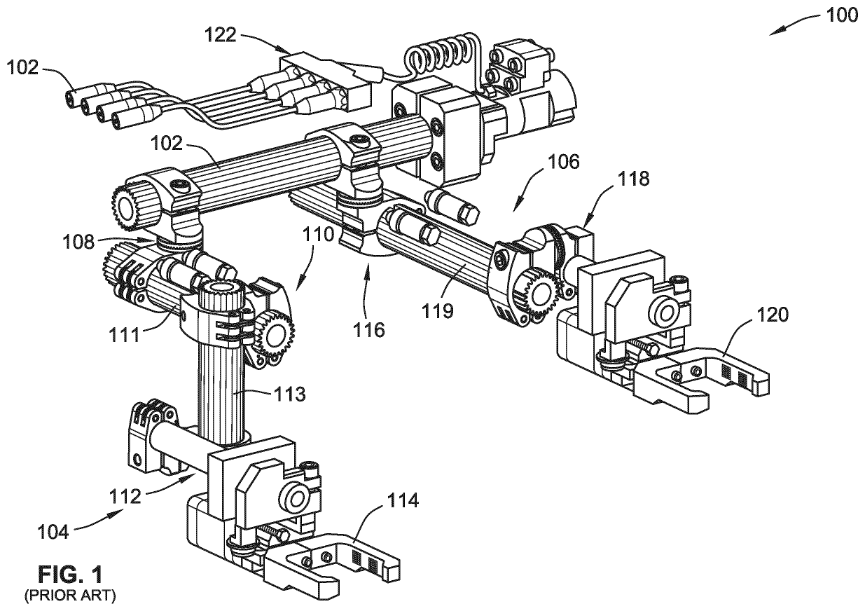

FIG. 1 illustrates a system 100 for transferring a workpiece, in accordance with an example. The system 100 that includes a tube 102 to which arm 104 and arm 106 are attached. The arms 104, 106 can also be referred to as tooling assemblies.

The arms 104, 106 are each configured as articulated arms rotatably-coupled to the tube 102 and having a plurality of arm linkages (e.g., tubes) rotatably-coupled to each other at respective joints. For example, the arm 104 has joint 108, joint 110, and joint 112. The joint 110 is coupled to the joint 108 via tube 111, and the joint 112 is coupled to the joint 110 via tube 113. The arm 104 further has an end-effector 114 (e.g., a g ripper) configured to attach or capture a workpiece.

Similarly, the arm 106 has joint 116 and joint 118, which is coupled to the joint 116 via tube 119. The arm 106 further has an end-effector 120 (e.g., a gripper) configured to attach or capture a workpiece.

The joints 108, 110, 112, 116, 118 are manually adjustable. Particularly, to place the arms 104, 106 in a particular configuration, the joints are rotated manually to place the arms 104, 106 in a particular configuration and place the end-effectors 114, 120 at a particular position and orientation suitable for a particular workpiece. Once the arms 104, 106 are placed at a particular configuration corresponding to the workpiece and the operation to be performed, the joints 108, 110, 112, 116, 118 are manually locked.

In an example, the system 100 can have a fluid subsystem 122 configured to provide pressurized fluid (e.g., compressed air) to actuate the end-effector 114, 120 to grip a workpiece.

As mentioned above, the joints 108, 110, 112, 116, 118 are manually adjustable. Thus, for every different workpiece or “job,” an operator manually adjusts the joints 108, 110, 112, 116, 118 to place them in a particular configuration. This process can be tedious and time consuming.

Further, as depicted in FIG. 1, the joints 108, 110, 112, 116, 118 and the tubes 111, 113, 119 are large, and therefore the system 100 may occupy a large space, which might not be desirable in some facilities. It may thus be desirable to have a compact system that is electronically actuated to enhance performance and characteristics of a workpiece transfer system.

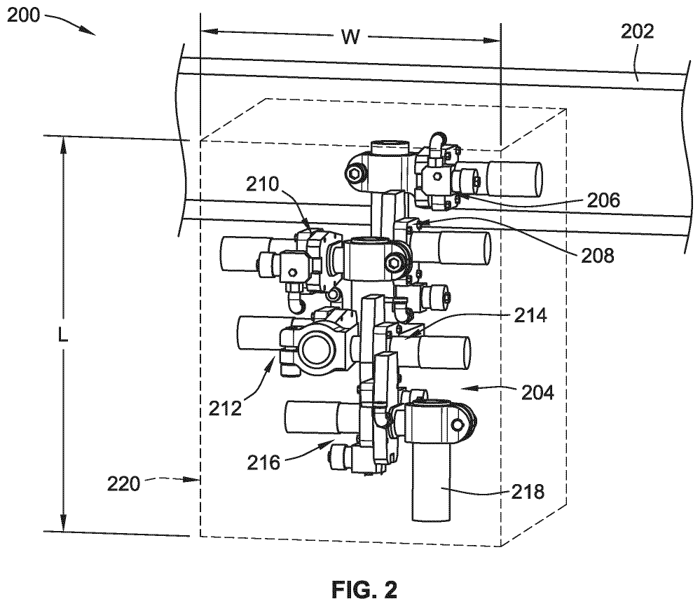

FIG. 2 illustrates a partial view of a system 200, in accordance with an example implementation. The system 200 that includes a rail 202 and a plurality of arms such as arm 204 coupled to the rail 202. Only a portion of the rail 202 and one arm are shown in FIG. 2 to reduce visual clutter in the drawing, but it should be understood that more arms can be attached to the rail 202.

The arm 204 can also be referred to as a tooling assembly. The arm 204 is configured as an articulated arm coupled to the rail 202 and having a plurality of arm linkages rotatably-coupled to each other at respective joints. Once the arm 204 is placed at a particular configuration corresponding to the workpiece and the operation to be performed, the arm 204 is locked in place (e.g., the joints are locked and prevented from rotating).

Particularly, in the example implementation shown in FIG. 2, the arm 204 can have six joints: joint 206, joint 208, joint 210, joint 212, joint 214, and joint 216. As described in more details below, the joints may have respective tubes to couple the joints to each other. Further, a tube 218 can be coupled to the joint 216 (the end joint), and an end-effector (e.g., gripper, suction cup, etc.) can be coupled to the tube 218.

The joints 206-216 can be actuated via electric motors as described below, to place the arm 204 is a particular configuration, and place the end-effector in a particular position and orientation. The six joints mimic the movement of a six degrees of freedom robotic manipulator, for example. The rotary positions of the joints 206-216 relative to each other can be adjusted automatically as desired via controller by sending command signals to the respective electric motors. This way, the system 200 can adapt to different workpieces or “jobs” without human, manual adjustment.

The system 200 can have a rail actuator (not shown) coupled to the rail 202. The system 200 is used to perform a transfer operation in which a workpiece is moved from a first workstation to a second workstation adjacent the first workstation. After moving the workpiece to the second workstation, the system 200 returns to the first workstation to repeat the transfer operation with respect to the next workpiece. For example, the first workstation could include a first machine that performs a first operation with respect to the workpiece, and the second workstation could include a second machine that performs a second operation with respect to the workpiece. During the transfer operation, the rail actuator moves the rail 202 and the arm 204 coupled to the rail 202. The arm 204 has an end-effector that is attached to the workpiece, which thus moves along with the rail 202 and the arm 204.

The arm 204 can be positioned in multiple desired configurations with respect to the rail 202 by actuating the electric motors. The desired configuration is dependent upon the geometry and type of the workpiece that is to be handled by the system 200. In an example, a large number of cycles of the transfer operation are performed with respect to a single type of workpiece, with each of the individual workpieces of a certain type having a certain geometry. When it is desired to use the system 200 with a different type of workpiece having a different geometry, the configurations of some or all of the arms (e.g., the arm 204) can be changed so that they are configured in a manner suited for use with the different workpiece.

As shown in FIG. 2, the joints 206-216 are compact compared to the joints 108, 110, 112, 116, 118 of the system 100. With this configuration, the joints 206-216 can rotate in tight spaces to place an end-effector coupled to the tube 218 anywhere within a spatial envelope 220 represented in FIG. 2 as a rectangular prism having length “L” and width “W.”

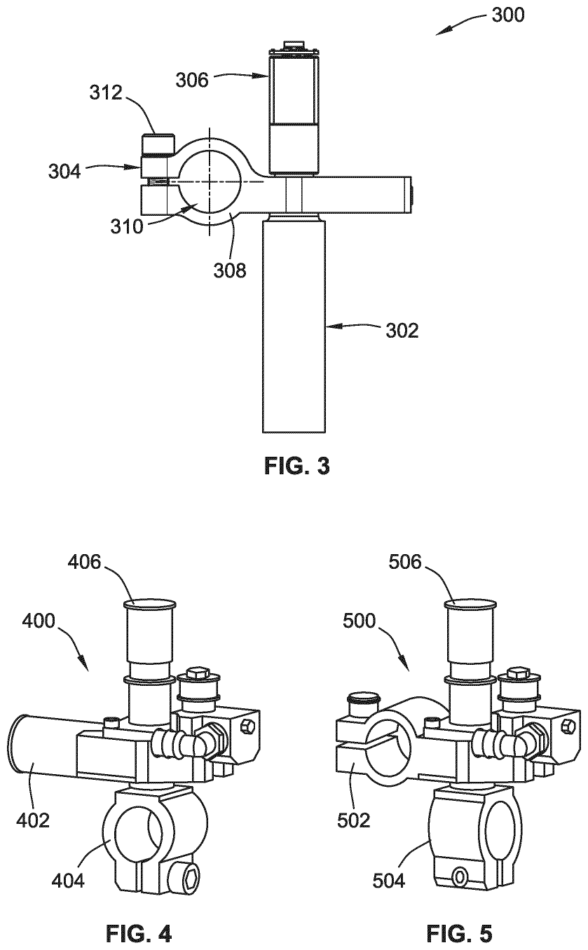

FIG. 3 illustrates a partial side view of a joint 300, in accordance with an example implementation. The joint 300 can be used as any of the joints of the arm 204 of the system 200, for example.

As shown, the joint 300 includes a tube 302, a clamp 304 that is perpendicular to the tube 302, and an electric motor 306. The electric motor 306 is disposed in line with the tube 302, and is configured to rotate the clamp 304, for example.

The clamp 304 can generally include any fastening device used to hold or secure an object (e.g., a tube or end-effector). For example, the clamp 304 can have a split ring 308 with a hole 310 through which an object (e.g., a tube or end-effector) can be disposed, and a fastener 312 tightens the grip of the split ring 308 on the object such that the object rotates with the clamp 304 when the electric motor 306 is actuated.

If the joint 300 represent an intermediate joint (e.g., one of the joints 208-214), a tube (similar to the tube 302) of a subsequent joint can be inserted through the hole 310 of the clamp 304 to couple the joints to each other. This way, when the electric motor 306 of the joint 300 rotates, the entire subsequent joint rotates therewith. Further, the tube 302 of the joint 300 can be inserted into a clamp of a preceding joint, such that when an electric motor of the preceding joint is actuated, the joint 300 rotates.

If the joint 300 is a terminal joint (e.g., the joint 216) a tubular member of an end-effector can be inserted into the clamp 304 to couple the end-effector to the joint 300 to move therewith. The configuration of the joint 300 is an example for illustration. Other configurations could be used as shown in FIGS. 4-5.

FIG. 4 illustrates a joint 400, in accordance with an example implementation. The joint 400 is another example joint that can be used in the system 200.

Similar to the joint 300, the joint 400 also includes a tube 402, a clamp 404, and an electric motor 406. However, rather than the electric motor 406 being in line with the tube 402, the electric motor 406 is in line with the clamp 404. Thus, the position/orientation of the tube 402 and the clamp 404 are switched relative to the configuration of the joint 300.

FIG. 5 illustrates a joint 500, in accordance with an example implementation. The joint 500 is another example joint that can be used in the system 200.

Rather than having a tube and a clamp like the joint 300 and the joint 400, the joint 500 has a first clamp 502 and a second clamp 504 perpendicular to each other, and have respective holes in perpendicular planes relative to teach other (e.g., the first clamp 502 has a different orientation relative to the second clamp 504). The joint 500 has an electric motor 506 in line with the second clamp 504.

To couple the joint 500 to another joint, a tube can be placed in the second clamp 504, for example, and also placed in a respective clamp of an adjacent joint. This way, when the electric motor 506 is actuated, the adjacent joint is rotated.

Thus, various configurations of joints could be used. The joints 206-216 of the system 200 are configured similar to the joint 400, as an example. In the description below, the joint 400 is used an as example to illustrate features of the disclosure. However, it should be understood that the features are also applicable to the joint 300 or the joint 500.

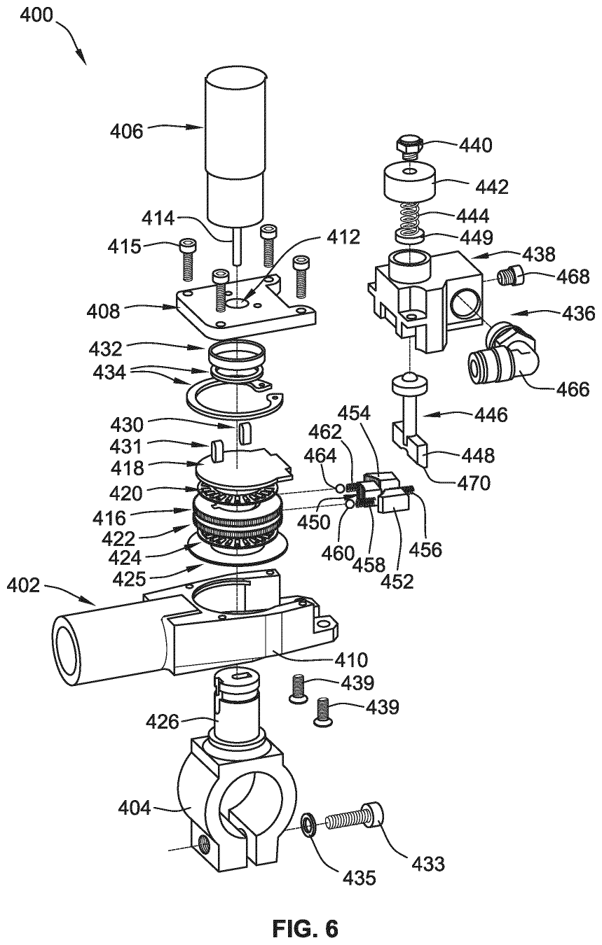

FIG. 6 illustrates a perspective exploded view of the joint 400, in accordance with an example implementation. The joint 400 has a motor mount 408 to which the electric motor 406 is mounted, and which facilitates coupling the electric motor 406 to a main housing 410 of the joint 400.

As depicted, the motor mount 408 can have a central hole 412 through which an output shaft 414 of the electric motor 406 is disposed. The motor mount 408 is affixed to the main housing 410 via fasteners (e.g., four fasteners) such as fastener 415 disposed through holes in the motor mount 408 and respective holes in the main housing 410. As shown, the tube 402 is coupled to the main housing 410.

The joint 400 has a gear assembly 416 that includes a thrust cover 418, a first thrust bearing 420 (e.g., upper thrust bearing), a gear 422, a second thrust bearing 424 (e.g., bottom thrust bearing), and a thrust ring cover 425. With this configuration, the gear 422 is interposed between the first thrust bearing 420 and the second thrust bearing 424. Also, the assembly of the gear 422, the first thrust bearing 420, and the second thrust bearing 424 is interposed between the thrust cover 418 and the thrust ring cover 425.

As depicted, the clamp 404 has a clamp shaft 426 configured to be disposed through the main housing 410 to be coupled to both the output shaft 414 of the electric motor 406 and the gear 422 of the gear assembly 416. For example, the clamp shaft 426 can have an internal keyway, and a motor key 430 can be inserted partially in such internal keyway and partially in another keyway in the output shaft 414 of the electric motor 406 to rotatably couple the output shaft 414 to the clamp shaft 426. Similarly, the clamp shaft 426 can have an external keyway, and a gear key 431 can be inserted in such external keyway and in another keyway in the gear 422 to rotatably couple the gear 422 to the clamp shaft 426.

The joint 400 can have a radial bearing 432 disposed about the clamp shaft 426 and configured to allow the clamp shaft 426 (and the clamp 404 as a whole) to rotate relative to the main housing 410. Further, retaining clips 434 can be used to retain the clamp 404 to the main housing 410.

The clamp 404 can have a fastener 433 and a washer 435. The fastener 433 can be disposed through the clamp 404 to tighten it about an object such as a tube (similar to the tube 402) of an adjacent joint or any cylindrical object (e.g., part of an end-effector).

The joint 400 further includes a locking module 436 that is configured to lock the clamp shaft 426 in position (e.g., at a particular rotational position) or unlock the clamp shaft 426 to allow it to rotate via the electric motor 406. As described in more details below, the locking module 436 can include a pneumatic actuation mechanism that uses pressurized fluid (e.g., air) to unlock the clamp shaft 426 and allow the electric motor 406 to rotate the clamp 404.

The locking module 436 includes a locking module housing 438 that is mounted to the main housing 410 via fasteners, such as fastener 439, disposed through holes in the main housing 410 and respective holes in the locking module housing 438. The joint 400 can include a pressure relief muffler 440 and a spring cap 442 mounted to the locking module housing 438.

The locking module housing 438 houses several components therein including a lock spring 444, which has a first end resting against the spring cap 442 and a second end resting against a piston 446 to bias the piston 446 downward in FIG. 6. The piston 446 can include or can be mounted to a locking wedge 448 configured to interact with pawls to lock and unlock the gear 422.

Particularly, the joint 400 includes a center pawl 450, a first side pawl 452 disposed laterally on one side of the center pawl 450, and a second side pawl 454 disposed laterally on the other side of the center pawl 450. The joint 400 includes a center pawl spring 456 that has a first end resting against the locking module housing 438 and a second end resting against the center pawl 450 to bias the center pawl 450 toward the gear 422.

The joint 400 also includes a side pawl spring 458 disposed partially in a channel formed in the first side pawl 452 and resting against a ball 460. Similarly, the joint 400 includes a side pawl spring 462 disposed partially in a channel formed in the second side pawl 454 and resting against a ball 464. As described below, the balls 460, 464 are disposed in a groove formed in the gear 422, and the side pawl springs 458, 462 bias their respective side pawls away from the gear 422 unless the locking wedge 448 forces the side pawls toward the gear 422.

In an example, the piston 446 is pneumatically actuated. A fitting 466 can be coupled to the locking module housing 438 to provide pressurized fluid thereto. The locking module housing 438 operates as a manifold that has internal fluid passages configured to route the pressurized fluid to the piston 446 to move it. When fluid supply stops, a bleed-off fitting 468 mounted to the locking module housing 438 releases fluid and allows the lock spring 444 to return the piston 446 to an unactuated position, thereby engaging the side pawls 452, 454 with the gear 422 to prevent it from rotating as described in more details below.

The joint 400 can have a piston seal 449 disposed about a stem of the piston 446 to prevent fluid leakage around the piston 446. Further, the locking wedge 448 can have a tapered surface 470 that interacts with respective tapered surfaces of the first side pawl 452 and the second side pawl 454 causing them to move toward the gear 422 or away therefrom to lock and unlock the gear 422.

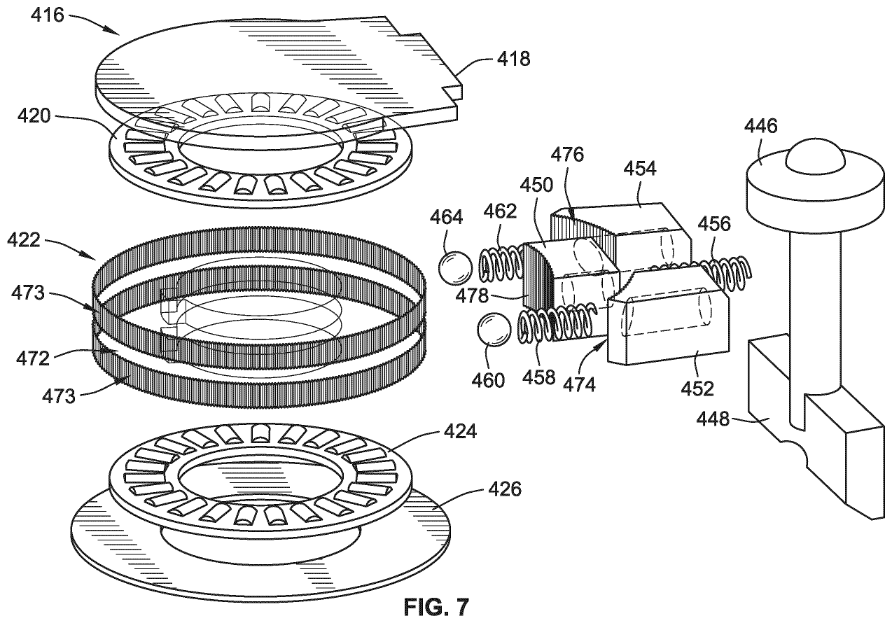

FIG. 7 illustrates a partial exploded perspective view of the gear assembly 416, in accordance with an example implementation. As shown, the gear 422 is configured as a wheel having a central groove 472 and having teeth 473 disposed about an exterior surface thereof. The central groove 472 accommodates the balls 460, 464 therein to allow the side pawl spring 458 to push the first side pawl 452 away from the gear 422 and allow the side pawl spring 462 to push the second side pawl 454 away from the gear 422.

In an example, the first side pawl 452 is configured as curved bar or block having teeth 474 configured to engage the teeth 473 of the gear 422 to prevent the gear 422 from rotating when the piston 446 moves downward and the locking wedge 448 pushes the first side pawl 452 toward the gear 422. Similarly, the second side pawl 454 is configured as curved bar or block having teeth 476 configured to engage the teeth 473 of the gear 422 to prevent the gear 422 from rotating when the piston 446 moves downward and the locking wedge 448 pushes the second side pawl 454 toward the gear 422. As depicted, with this configuration, the direction of movement of the side pawls 452, 454 (in plane with the gear 422) is perpendicular to the direction of movement of the piston 446 (e.g., parallel to the axis of the output shaft 414 of the electric motor 406).

The center pawl 450 also has teeth 478 that engage the teeth 473 of the gear 422. However, the center pawl 450 is not configured to lock the gear 422. Rather, if the gear 422 rotates, the center pawl 450 bounces away and toward the gear 422 via the center pawl spring 456. The pitch of the teeth 478 of the center pawl 450 and of the teeth 473 of the gear 422 determines the increment by which the gear 422 can rotate. As an example, the pitch can be about 1.5 degrees. In this example, the gear 422 can rotate in 1.5 degree increments when the electric motor 406 is actuated and the piston 446 is actuated to the unlocked position.

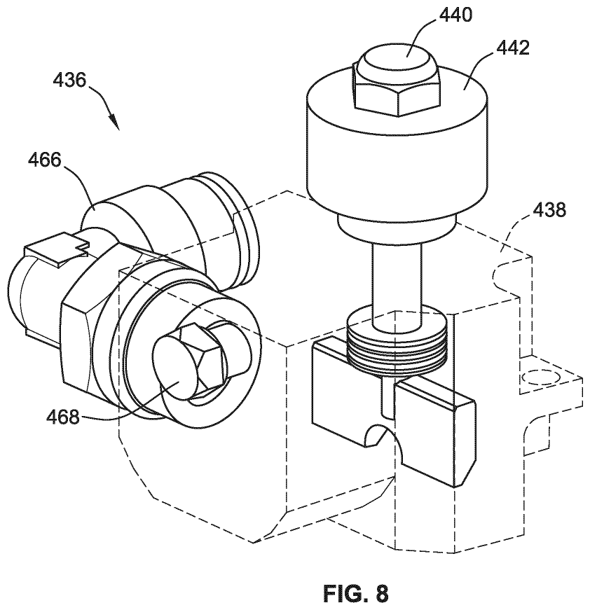

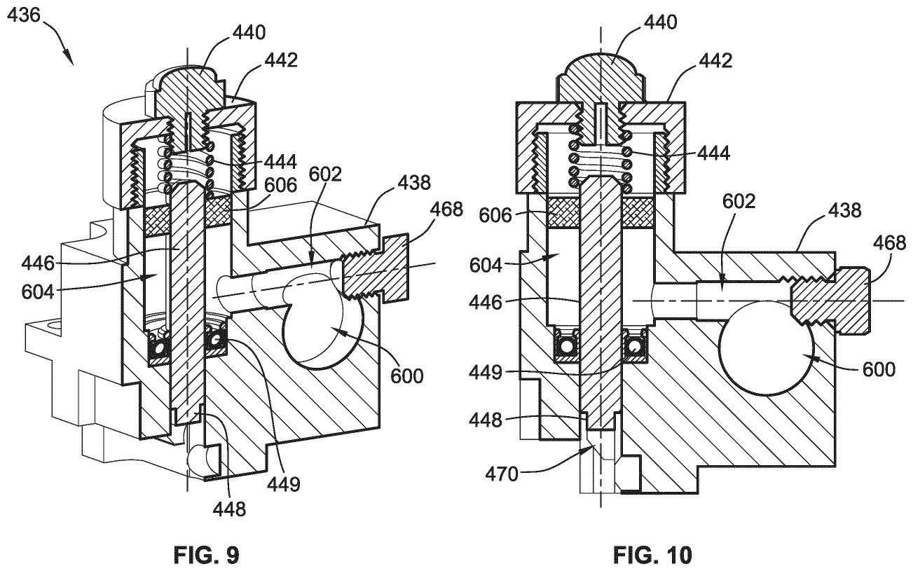

FIG. 8 illustrates a transparent perspective view of the locking module 436, FIG. 9 illustrates a perspective cross-sectional view of the locking module 436, and FIG. 10 illustrates a side-cross sectional view of the locking module 436, in accordance with an example implementation. FIGS. 8-10 are described together.

Fluid (e.g., air or gas) is provided (e.g., from a source of gas such as a compressor) through the fitting 466 to the locking module housing 438, which as mentioned above is configured as a manifold having internal fluid passages such as fluid passage 600 and fluid passage 602 shown in FIGS. 9-10. Fluid is then provided to piston chamber 604 in which the piston 446 is disposed.

The piston 446 has a piston head or piston cap 606 on which fluid in the piston chamber 604 applies a fluid force in an upward direction with respect to FIGS. 9-10 against the lock spring 444. When the fluid force is sufficient to overcome the lock spring 444, the piston 446 moves upward, causing the locking wedge 448 to disengage from the first side pawl 452 and the second side pawl 454. This allows the side pawl spring 458 to push the first side pawl 452 away from the gear 422 to disengage from gear 422, and also allows the side pawl spring 462 to push the second side pawl 454 away from the gear 422 to disengage from gear 422. As both side pawls 452, 454 disengage from the gear 422, the gear 422 is free to rotate with the electric motor 406. If pressure level inside the piston chamber 604 exceeds a threshold value, fluid is released via the pressure relief muffler 440 to the environment.

To re-engage the side pawls 452, 454 with the gear 422 to lock it in place, fluid flow to the lock module 436 is stopped. Pressurized fluid in the locking module housing 438 (e.g., in the piston chamber 604, and the fluid passages 600, 602) is allowed to bleed off (e.g., is released to the environment) through the bleed-off fitting 468. As fluid is released to the environment, pressure level in the piston chamber 604 decreases, thereby causing the lock spring 444 to push the piston 446 downward. The locking wedge 448, and particularly its tapered surface 470 thereof, engages the side pawls 452, 454, thereby pushing them toward the gear 422 to engage it and lock it in place. Particularly, the teeth 474 of the first side pawl 452 and the teeth 476 of the second side pawl 454 engage the teeth 473 of the gear 422.

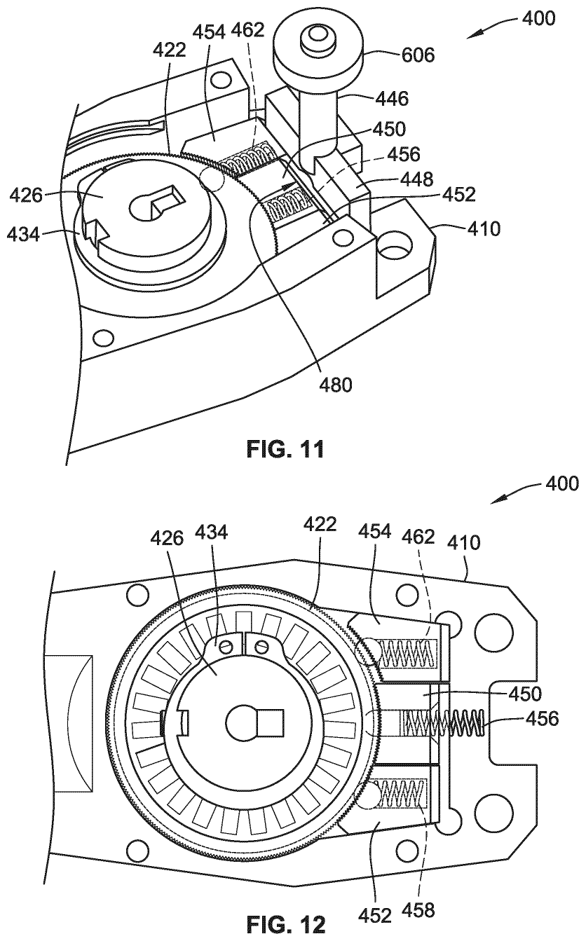

FIG. 11 illustrates a partial perspective view of the joint 400, and FIG. 12 illustrates a partial top view of the joint 400, in accordance with an example implementation. In FIGS. 11-12, the center pawl 450 and the side pawls 452, 454 are transparent to show their respective pawl springs. The gear 422 is also transparent. As shown, the locking wedge 448 can have an arch 480 that allows the center pawl spring 456 therethrough when the locking wedge 448 moves downward to move the side pawls 452, 454 toward the gear 422.

FIGS. 11-12 show the first side pawl 452 in an engaged position where the teeth 474 thereof engage the teeth 473 of the gear 422 to lock it in place, while the second side pawl 454 is shown in a disengaged position where the teeth 476 are disengaged from the gear 422. This is for illustration only. It should be understood that the side pawls 452, 454 engage or disengage the gear 422 together.

Referring to FIGS. 6, 11-12 together, as mentioned above, the output shaft 414 of the electric motor 406 engages with the clamp shaft 426 to rotate it via the motor key 430. The clamp shaft 426 can then rotate the gear 422 via the gear key 431.

If the side pawls 452, 454 are in the engaged position where the piston 446 has moved downward causing the locking wedge 448 to push the side pawls 452, 454 inward toward the gear 422 to engage it, the gear 422 is locked in place. Particularly, if the gear 422 tries to rotate in a first rotational direction (clockwise direction in FIGS. 11-12), it has to move the first side pawl 452 engaged therewith, but the first side pawl 452 is constrained from moving by being wedged against the interior side surfaces of the main housing 410. Similarly, if the gear 422 tries to rotate in a second rotational direction (a counter-clockwise direction in FIGS. 11-12), opposite the first rotation direction, it has to move the second side pawl 454 engaged therewith, but the second side pawl 454 is constrained from moving by being wedged against the interior side surfaces of the main housing 410. Thus, the gear 422 remains locked in place, and the clamp shaft 426 cannot rotate (i.e., the clamp 404 is locked in place).

If pressurized fluid is provided to the locking module housing 438 as described above with respect to FIGS. 8-10, the piston 446 is actuated (e.g., moves upward), thereby causing the locking wedge 448 to disengage from the side pawls 452, 454. The side pawl springs 458, 462 then push their respective side pawls in an outward direction away from the gear 422, thus disengaging from the gear 422. The gear 422 slides relative to the balls 460, 464 disposed in the central groove 472.

In this state, the gear 422 is free to rotate. As such, the electric motor 406 can rotate the clamp shaft 426.

In an example, the center pawl 450 is keyed to the main housing 410. For instance, the center pawl 450 can have a bottom protrusion that is disposed in a channel formed in the main housing 410 such that the center pawl 450 can move outward and inward only, but is constrained from moving laterally or sideways. As the gear 422 rotates, the center pawl 450 bounces outward against the center pawl spring and inward by the center pawl spring 456.

Thus, despite the teeth 478 of the center pawl 450 engaging the teeth 473 of the gear 422, the center pawl 450 bounces outward as the gear 422 rotates and allows the gear 422 to rotate. As mentioned above, the gear 422 can move incrementally. The rotational increment of the gear 422, and thus of the clamp 404, is determined by the pitch of the teeth 478 of the center pawl 450 and the teeth 473 of the gear 422.

Notably, if electric power or fluid supply is cut off due to any failure in the system, the joint 400 defaults to a locked position. Particularly, as fluid supply is cut off, fluid is bled off and the piston 446 moves downward to the locked position, pushing the side pawls 452, 454 against the gear 422 to lock it in position.

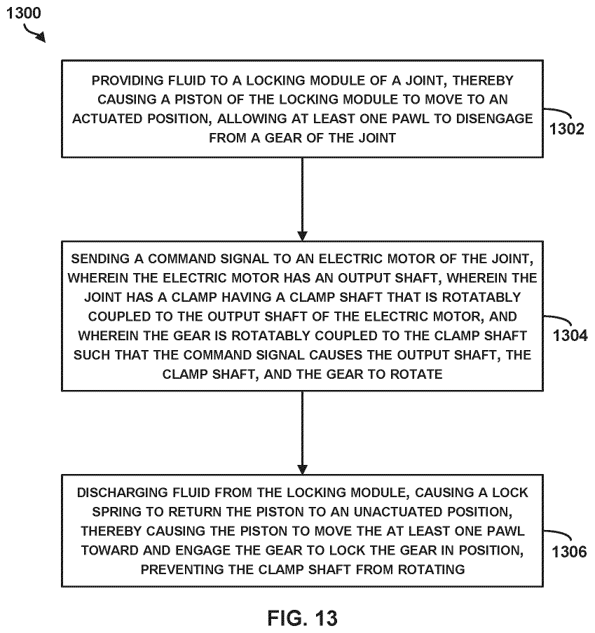

FIG. 13 is a flowchart of a method 1300 for operating a joint, in accordance with an example implementation. The method 1300 can be used to operate the joint 300, 400, or 500, for example. The method 1300 may include one or more operations, functions, or actions as illustrated by one or more of blocks 1302-1306.

Although the blocks are illustrated in a sequential order, these blocks may also be performed in parallel, and/or in a different order than those described herein. Also, the various blocks may be combined into fewer blocks, divided into additional blocks, and/or removed based upon the desired implementation. It should be understood that for this and other processes and methods disclosed herein, flowcharts show functionality and operation of one possible implementation of present examples. Alternative implementations are included within the scope of the examples of the present disclosure in which functions may be executed out of order from that shown or discussed, including substantially concurrent or in reverse order, depending on the functionality involved, as would be understood by those reasonably skilled in the art.

At block 1302, the method 1300 includes providing fluid to a locking module (e.g., the locking module 436) of a joint (e.g., the joint 400), thereby causing a piston (e.g., the piston 446) of the locking module to move to an actuated position (e.g., upward in FIGS. 9-12), allowing at least one pawl (e.g., the side pawls 452, 454) to disengage from a gear (e.g., the gear 422) of the joint.

At block 1304, the method 1300 includes sending a command signal to an electric motor (e.g., the electric motor 406) of the joint, wherein the electric motor has an output shaft (e.g., the output shaft 414), wherein the joint has a clamp (e.g., the clamp 404) having a clamp shaft (e.g., the clamp shaft 426) that is rotatably coupled to the output shaft of the electric motor, and wherein the gear is rotatably coupled to the clamp shaft such that the command signal causes the output shaft, the clamp shaft, and the gear to rotate.

At block 1306, the method 1300 includes discharging fluid (e.g., via the bleed-off fitting 468) from the locking module, causing a lock spring (e.g., the lock spring 444) to return the piston to an unactuated position (e.g., downward in FIGS. 9-12), thereby causing the piston to move the at least one pawl toward and engage the gear to lock the gear in position, preventing the clamp shaft from rotating.

The method 1300 can further include other steps as described throughout herein.

The detailed description above describes various features and operations of the disclosed systems with reference to the accompanying figures. The illustrative implementations described herein are not meant to be limiting. Certain aspects of the disclosed systems can be arranged and combined in a wide variety of different configurations, all of which are contemplated herein.

Further, unless context suggests otherwise, the features illustrated in each of the figures may be used in combination with one another. Thus, the figures should be generally viewed as component aspects of one or more overall implementations, with the understanding that not all illustrated features are necessary for each implementation.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

Further, devices or systems may be used or configured to perform functions presented in the figures. In some instances, components of the devices and/or systems may be configured to perform the functions such that the components are actually configured and structured (with hardware and/or software) to enable such performance. In other examples, components of the devices and/or systems may be arranged to be adapted to, capable of, or suited for performing the functions, such as when operated in a specific manner.

By the term “substantially” or “about” it is meant that the recited characteristic, parameter, or value need not be achieved exactly, but that deviations or variations, including for example, tolerances, measurement error, measurement accuracy limitations and other factors known to skill in the art, may occur in amounts that do not preclude the effect the characteristic was intended to provide.

The arrangements described herein are for purposes of example only. As such, those skilled in the art will appreciate that other arrangements and other elements (e.g., machines, interfaces, operations, orders, and groupings of operations, etc.) can be used instead, and some elements may be omitted altogether according to the desired results. Further, many of the elements that are described are functional entities that may be implemented as discrete or distributed components or in conjunction with other components, in any suitable combination and location.

While various aspects and implementations have been disclosed herein, other aspects and implementations will be apparent to those skilled in the art. The various aspects and implementations disclosed herein are for purposes of illustration and are not intended to be limiting, with the true scope being indicated by the following claims, along with the full scope of equivalents to which such claims are entitled. Also, the terminology used herein is for the purpose of describing particular implementations only, and is not intended to be limiting.

Implementations of the present disclosure can thus relate to one of the enumerated example embodiments (EEEs) listed below.

EEE 1 is a joint of an arm of a workpiece transfer system, the joint comprising: an electric motor having an output shaft; a clamp having a clamp shaft that is rotatably coupled to the output shaft of the electric motor; a gear that is rotatably coupled to the clamp shaft; a locking module comprising a piston and a lock spring applying a biasing force on the piston; and at least one pawl movable by the piston, wherein (i) as the piston is actuated, the piston moves against the lock spring, allowing the at least one pawl to move away from the gear, and allowing the gear and the clamp shaft to rotate with the output shaft of the electric motor, and (ii) as the piston is unactuated, the lock spring biases the piston, causing the at least one pawl to move toward and engage the gear to lock the gear in position, thereby preventing the clamp shaft from rotating.

EEE 2 is the joint of EEE 1, wherein the locking module further comprises a locking wedge coupled to the piston, wherein the at least one pawl is movable by the locking wedge, wherein (i) as the piston is actuated, the piston causes the locking wedge to disengage from the at least one pawl, allowing the at least one pawl to move away from the gear, and (ii) as the piston is unactuated, the lock spring biases the piston and the locking wedge toward the at least one pawl, causing the at least one pawl to move toward the gear.

EEE 3 is the joint of EEE 2, wherein the locking wedge comprises a tapered surface, and wherein the at least one pawl comprises a respective tapered surface such that as the locking wedge moves toward the at least one pawl, the tapered surface of the locking wedge engages the respective tapered surface of the at least one pawl, causing the at least one pawl to move in a direction that is perpendicular to a direction of movement of the piston and the locking wedge.

EEE 4 is the joint of any of EEEs 1-3, wherein the at least one pawl comprises: a first side pawl configured to allow or prevent rotation of the gear in a first rotational direction; and a second side pawl configured to allow or prevent rotation of the gear in a second rotational direction, opposite the first rotational direction.

EEE 5 is the joint of EEE 4, further comprising: a center pawl disposed between the first side pawl and the second side pawl; and a center pawl spring biasing the center pawl toward the gear such that the center pawl is configured to bounce away from and toward the gear as the gear rotates when the piston is actuated and the first side pawl and the second side pawl disengage from the gear.

EEE 6 is the joint of any of EEEs 1-5, further comprising: a pawl spring biasing the at least one pawl away from the gear, such that the piston moves the at least one pawl toward the gear against the pawl spring when the piston is unactuated, and the pawl spring moves the at least one pawl away from the gear when the piston is actuated.

EEE 7 is the joint of EEE 6, wherein the gear comprises a central groove, wherein the joint further comprises: a ball disposed in the central groove, wherein the pawl spring rests against the ball.

EEE 8 is the joint of any of EEEs 1-7, wherein the locking module comprises: a locking module housing comprising one or more internal fluid passages and a piston chamber in which is the piston is disposed, wherein to actuate the piston, fluid is provided to the locking module housing and flows to the piston chamber via the one or more internal fluid passages of the locking module housing to move the piston in the piston chamber against the lock spring to an actuated position.

EEE 9 is the joint of EEE 8, further comprising: a bleed-off fitting mounted to the locking module housing and configured to release fluid to an environment of the locking module housing to allow the lock spring to bias the piston to an unactuated position.

EEE 10 is the joint of any of EEEs 1-9, wherein the gear is interposed between a first thrust bearing and a second thrust bearing.

EEE 11 is the joint of any of EEEs 1-10, further comprising: a tube that is perpendicular to the clamp.

EEE 12 is the joint of any of EEEs 1-11, wherein the clamp is a first clamp, and wherein the joint further comprises: a second clamp perpendicular to the first clamp.

EEE 13 is a system comprising: a transfer rail; and a plurality of arms coupled to the transfer rail, each arm having a plurality of joints, wherein a joint of the plurality of joints comprises: an electric motor having an output shaft, a clamp having a clamp shaft that is rotatably coupled to the output shaft of the electric motor, a gear that is rotatably coupled to the clamp shaft, a locking module comprising a piston and a lock spring applying a biasing force on the piston, at least one pawl movable by the piston, wherein (i) as the piston is actuated, the piston moves against the lock spring, allowing the at least one pawl to move away from the gear, and allowing the gear and the clamp shaft to rotate with the output shaft of the electric motor, and (ii) as the piston is unactuated, the lock spring biases the piston, causing the at least one pawl to move toward and engage the gear to lock the gear in position, thereby preventing the clamp shaft from rotating.

EEE 14 is the system of EEE 13, wherein the joint further comprises: a tube perpendicular to the clamp, wherein the tube is configured to be clamped by a respective clamp of an adjacent joint of the arm.

EEE 15 is the system of any of EEEs 13-14, wherein the locking module further comprises a locking wedge coupled to the piston, wherein the at least one pawl is movable by the locking wedge, wherein (i) as the piston is actuated, the piston causes the locking wedge to disengage from the at least one pawl, allowing the at least one pawl to move away from the gear, and (ii) as the piston is unactuated, the lock spring biases the piston and the locking wedge toward the at least one pawl, causing the at least one pawl to move toward the gear.

EEE 16 is the system of any of EEEs 13-15, wherein the at least one pawl comprises: a first side pawl configured to allow or prevent rotation of the gear in a first rotational direction; and a second side pawl configured to allow or prevent rotation of the gear in a second rotational direction, opposite the first rotational direction.

EEE 17 is the system of EEE 16, wherein the joint further comprises: a center pawl disposed between the first side pawl and the second side pawl; and a center pawl spring biasing the center pawl toward the gear such that the center pawl is configured to bounce away from and toward the gear as the gear rotates when the piston is actuated and the first side pawl and the second side pawl disengage from the gear.

EEE 18 is the system of any of EEEs 13-17, a pawl spring biasing the at least one pawl away from the gear, such that the piston moves the at least one pawl toward the gear against the pawl spring when the piston is unactuated, and the pawl spring moves the at least one pawl away from the gear when the piston is actuated.

EEE 19 is the system of any of EEEs 13-18, wherein the locking module comprises: a locking module housing comprising one or more internal fluid passages and a piston chamber in which is the piston is disposed, wherein to actuate the piston, fluid is provided to the locking module housing and flows to the piston chamber via the one or more internal fluid passages of the locking module housing to move the piston in the piston chamber against the lock spring to an actuated position; and a bleed-off fitting mounted to the locking module housing and configured to release fluid to an environment of the locking module housing to allow the lock spring to bias the piston to an unactuated position.

EEE 20 is a method comprising: providing fluid to a locking module of a joint, thereby causing a piston of the locking module to move to an actuated position, allowing at least one pawl to disengage from a gear of the joint; sending a command signal to an electric motor of the joint, wherein the electric motor has an output shaft, wherein the joint has a clamp having a clamp shaft that is rotatably coupled to the output shaft of the electric motor, and wherein the gear is rotatably coupled to the clamp shaft such that the command signal causes the output shaft, the clamp shaft, and the gear to rotate; and discharging fluid from the locking module, causing a lock spring to return the piston to an unactuated position, thereby causing the piston to move the at least one pawl toward and engage the gear to lock the gear in position, preventing the clamp shaft from rotating.

What is claimed is:

1. A joint of an arm of a workpiece transfer system, the joint comprising:
an electric motor having an output shaft;
a clamp having a clamp shaft that is rotatably coupled to the output shaft of the electric motor;
a gear that is rotatably coupled to the clamp shaft;
a locking module comprising a piston and a lock spring applying a biasing force on the piston; and
at least one pawl movable by the piston, wherein (i) as the piston is actuated, the piston moves against the lock spring, allowing the at least one pawl to move away from the gear, and allowing the gear and the clamp shaft to rotate with the output shaft of the electric motor, and (ii) as the piston is unactuated, the lock spring biases the piston, causing the at least one pawl to move toward and engage the gear to lock the gear in position, thereby preventing the clamp shaft from rotating.

2. The joint of claim 1, wherein the locking module further comprises a locking wedge coupled to the piston, wherein the at least one pawl is movable by the locking wedge, wherein (i) as the piston is actuated, the piston causes the locking wedge to disengage from the at least one pawl, allowing the at least one pawl to move away from the gear, and (ii) as the piston is unactuated, the lock spring biases the piston and the locking wedge toward the at least one pawl, causing the at least one pawl to move toward the gear.

3. The joint of claim 2, wherein the locking wedge comprises a tapered surface, and wherein the at least one pawl comprises a respective tapered surface such that as the locking wedge moves toward the at least one pawl, the tapered surface of the locking wedge engages the respective tapered surface of the at least one pawl, causing the at least one pawl to move in a direction that is perpendicular to a direction of movement of the piston and the locking wedge.

4. The joint of claim 1, wherein the at least one pawl comprises:
a first side pawl configured to allow or prevent rotation of the gear in a first rotational direction; and
a second side pawl configured to allow or prevent rotation of the gear in a second rotational direction, opposite the first rotational direction.

5. The joint of claim 4, further comprising:
a center pawl disposed between the first side pawl and the second side pawl; and
a center pawl spring biasing the center pawl toward the gear such that the center pawl is configured to bounce away from and toward the gear as the gear rotates when the piston is actuated and the first side pawl and the second side pawl disengage from the gear.

6. The joint of claim 1, further comprising:
a pawl spring biasing the at least one pawl away from the gear, such that the piston moves the at least one pawl toward the gear against the pawl spring when the piston is unactuated, and the pawl spring moves the at least one pawl away from the gear when the piston is actuated.

7. The joint of claim 6, wherein the gear comprises a central groove, wherein the joint further comprises:
a ball disposed in the central groove, wherein the pawl spring rests against the ball.

8. The joint of claim 1, wherein the locking module comprises:
a locking module housing comprising one or more internal fluid passages and a piston chamber in which is the piston is disposed, wherein to actuate the piston, fluid is provided to the locking module housing and flows to the piston chamber via the one or more internal fluid passages of the locking module housing to move the piston in the piston chamber against the lock spring to an actuated position.

9. The joint of claim 8, further comprising:
a bleed-off fitting mounted to the locking module housing and configured to release fluid to an environment of the locking module housing to allow the lock spring to bias the piston to an unactuated position.

10. The joint of claim 1, wherein the gear is interposed between a first thrust bearing and a second thrust bearing.

11. The joint of claim 1, further comprising:
a tube that is perpendicular to the clamp.

12. The joint of claim 1, wherein the clamp is a first clamp, and wherein the joint further comprises:
a second clamp perpendicular to the first clamp.

13. A system comprising:
a transfer rail; and
a plurality of arms coupled to the transfer rail, each arm having a plurality of joints, wherein a joint of the plurality of joints comprises:
an electric motor having an output shaft,
a clamp having a clamp shaft that is rotatably coupled to the output shaft of the electric motor,
a gear that is rotatably coupled to the clamp shaft,
a locking module comprising a piston and a lock spring applying a biasing force on the piston,
at least one pawl movable by the piston, wherein (i) as the piston is actuated, the piston moves against the lock spring, allowing the at least one pawl to move away from the gear, and allowing the gear and the clamp shaft to rotate with the output shaft of the electric motor, and (ii) as the piston is unactuated, the lock spring biases the piston, causing the at least one pawl to move toward and engage the gear to lock the gear in position, thereby preventing the clamp shaft from rotating.

14. The system of claim 13, wherein the joint further comprises:
a tube perpendicular to the clamp, wherein the tube is configured to be clamped by a respective clamp of an adjacent joint of the arm.

15. The system of claim 13, wherein the locking module further comprises a locking wedge coupled to the piston, wherein the at least one pawl is movable by the locking wedge, wherein (i) as the piston is actuated, the piston causes the locking wedge to disengage from the at least one pawl, allowing the at least one pawl to move away from the gear, and (ii) as the piston is unactuated, the lock spring biases the piston and the locking wedge toward the at least one pawl, causing the at least one pawl to move toward the gear.

16. The system of claim 13, wherein the at least one pawl comprises:
a first side pawl configured to allow or prevent rotation of the gear in a first rotational direction; and
a second side pawl configured to allow or prevent rotation of the gear in a second rotational direction, opposite the first rotational direction.

17. The system of claim 16, wherein the joint further comprises:
a center pawl disposed between the first side pawl and the second side pawl; and
a center pawl spring biasing the center pawl toward the gear such that the center pawl is configured to bounce away from and toward the gear as the gear rotates when the piston is actuated and the first side pawl and the second side pawl disengage from the gear.

18. The system of claim 13, a pawl spring biasing the at least one pawl away from the gear, such that the piston moves the at least one pawl toward the gear against the pawl spring when the piston is unactuated, and the pawl spring moves the at least one pawl away from the gear when the piston is actuated.

19. The system of claim 13, wherein the locking module comprises:
a locking module housing comprising one or more internal fluid passages and a piston chamber in which is the piston is disposed, wherein to actuate the piston, fluid is provided to the locking module housing and flows to the piston chamber via the one or more internal fluid passages of the locking module housing to move the piston in the piston chamber against the lock spring to an actuated position; and
a bleed-off fitting mounted to the locking module housing and configured to release fluid to an environment of the locking module housing to allow the lock spring to bias the piston to an unactuated position.

20. A method comprising:
providing fluid to a locking module of a joint, thereby causing a piston of the locking module to move to an actuated position, allowing at least one pawl to disengage from a gear of the joint;
sending a command signal to an electric motor of the joint, wherein the electric motor has an output shaft, wherein the joint has a clamp having a clamp shaft that is rotatably coupled to the output shaft of the electric motor, and wherein the gear is rotatably coupled to the clamp shaft such that the command signal causes the output shaft, the clamp shaft, and the gear to rotate; and
discharging fluid from the locking module, causing a lock spring to return the piston to an unactuated position, thereby causing the piston to move the at least one pawl toward and engage the gear to lock the gear in position, preventing the clamp shaft from rotating.
